(19) United States
(12) Patent Application Publication
(10) Pub. No.: US 2005/0283812 A1
(43) Pub. Date: Dec. 22, 2005

(54) Multi-functional multimedia playing device

(76) Inventors: Soon-Keat Soo, Taipei (TW); Shih-Hsiung Weng, Taipei (TW)

Correspondence Address: EDWARDS & ANGELL, LLP, P.O. BOX 55874, BOSTON, MA, 02205, US

(21) Appl. No.: 10/871,132

(22) Filed: Jun. 18, 2004

(51) Int. Cl. H04N 7/173; H04N 7/16

(52) U.S. Cl. 725/100; 725/131; 725/139; 725/151

(57) ABSTRACT

A multi-functional multimedia playing device is proposed, which is designed for use to provide a variety of multimedia functions, including a digital photo display function, a video playback function, an audio playback function, and a video/audio recording function, all on a single unit of device, for the user to browse digital photos, watch video programs, listen to music and speeches, and record video/audio programs all from just a single unit of device.

### BACKGROUND OF THE INVENTION

1. Field of the Invention

This invention relates to multimedia technology, and more particularly, to a multi-functional multimedia playing device capable of providing a variety of multimedia functions, including a digital photo displaying function, a video playback function, an audio playback function, and a video/audio recording function, all on a single unit of device, for the user to browse digital photos, watch video programs, listen to audio (music and speeches), and record video/audio programs.

2. Description of Related Art

Presently, the consumer electronics market offers many different kinds of multimedia processing devices, such as digital photo browsers, MP3 players, VCD/DVD players, digital camcorders, and so on, which respectively allow the user to browse digital photos, watch video programs, listen to music and speeches, and record video/audio programs

One drawback to the aforementioned multimedia processing devices, however, is that the user can utilize each of them for just one multimedia function, namely, the digital photo browser only allows the user to browse digital photos, the MP3 player only allows the user to listen to audio programs, the VCD/DVD player only allows the user to watch video programs, and the digital camcorder only allows the user to record video programs. For this sake, the user needs to purchase four different kinds of devices to enjoy digital photo display function, video playback function, audio playback function, and video/audio recording function.

### SUMMARY OF THE INVENTION

It is therefore an objective of this invention to provide a multi-functional multimedia playing device which is capable of providing a digital photo display function, a video playback function, an audio playback function, and a video/audio recording function, all from a single unit of device so as to allow the user to enjoy all of these functions from just a single unit of device.

The multi-functional multimedia playing device according to the invention is integrally equipped on a single unit of device with a digital photo displaying module, a video playback module, an audio playback module, and a video/audio recording module; wherein the digital photo displaying module allows the user to browse digital photos, the video playback module to watch video programs, the audio playback module allows the user to listen to audio programs, and the video/audio recording module allows the user to record video programs that are produced from an external video/audio producing unit.

The multi-functional multimedia playing device according to the invention allows the user to enjoy various kinds of multimedia reproduction/recording functions all from a single unit of device, including a digital photo display function, a video playback function, an audio playback function, and a video/audio recording function.

### BRIEF DESCRIPTION OF DRAWINGS

The invention can be more fully understood by reading the following detailed description of the preferred embodiments, with reference made to the accompanying drawings, wherein:

FIG. 1 is a schematic block diagram showing the architecture of the multi-functional multimedia playing device according to the invention;

FIG. 2 is a schematic block diagram showing the architecture of another preferred embodiment of the multi-functional multimedia playing device according to the invention.

### DETAILED DESCRIPTION OF PREFERRED EMBODIMENTS

The multi-functional multimedia playing device according to the invention is disclosed in full details by way of preferred embodiments in the following with reference to the accompanying drawings.

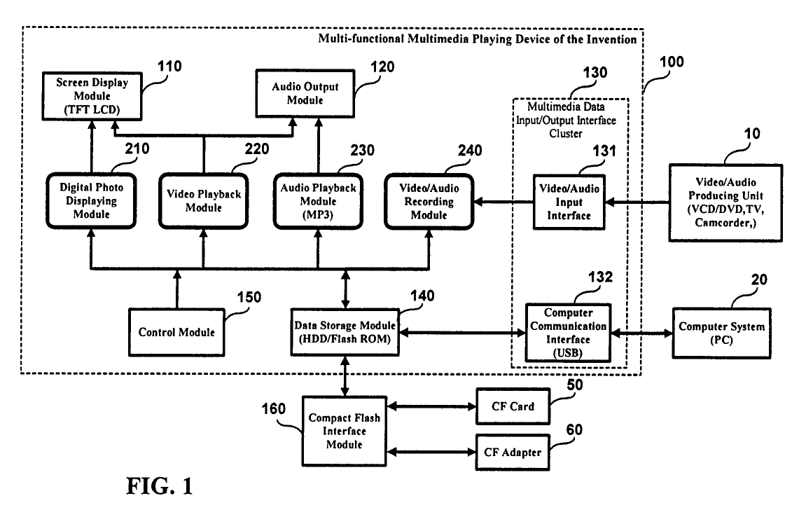

As shown in FIG. 1, the multi-functional multimedia playing device according to the invention (as the part enclosed in the dotted box indicated by the reference numeral 100) comprises: (a) a screen display module 110; (b) an audio output module 120; (c) a multimedia data input/output interface cluster 130; (d) a data storage module 140; (e) a control module 150; (f) a digital photo displaying module 210; (g) a video playback module 220; (h) an audio playback module 230; (i) a video/audio recording module 240; and (j) a compact flash interface module 160.

The screen display module 110 is, for example, a color TFT LCD (Thin Film Transistor Liquid Crystal Display) unit, which is used for displaying digital photos and digital videos as well as graphic user interfaces, text, and graphics.

The audio output module 120 includes an internal sound reproduction function and an external sound reproduction function, wherein the internal sound reproduction function utilizes a built-in loudspeaker (not shown) to convert the input audio signals directly into natural sound for broadcast to the surrounding environment, while the external sound reproduction function allows the user to use an external earphone set or loudspeaker (not shown) for the audio reproduction.

The multimedia data input/output interface cluster 130 includes, but not limited to, a video/audio input interface 131 and a computer communication interface 132, and can further includes a compact flash interface module 160. The video/audio input interface 131 is used to connect the multi-functional multimedia playing device of the invention 100 to an external video/audio producing unit 10, such as a VCD/DVD player, a TV unit, a camcorder, and so on, for transferring audio or video signals into the multi-functional multimedia playing device of the invention 100. The computer communication interface 132 is, for example, a USB (Universal Serial Bus) compliant communication interface, which allows the multi-functional multimedia playing device of the invention 100 to be externally connected to a computer system 20, such as a desktop computer, a notebook computer, and the like, for downloading multimedia data files from the computer system 20 into the multi-functional multimedia playing device of the invention 100.

The compact flash interface module 160 is used for connection to a compact flash card 50 and a compact flash adapter 60, wherein the compact flash adapter 60 is for example a 4-in-1 adapter that can be used for connection to various kinds of flash memory devices, such as SD (Secure Digital), MS (Memory Stick), MMC (Multimedia Card), and SM (Smart Media), for transferring multimedia data from flash memory devices to the multi-functional multimedia playing device of the invention 100.

The data storage module 140 includes, for example, a hard disk drive or a flash memory module, wherein the hard disk drive is used to store various kinds of multimedia data files, including, for example, digital photo files, digital video files (movies), digital audio files (music, speech, etc.), and so on; while the flash memory module is used to store related control programs.

The control module 150 is a user-machine interface that includes a set of buttons (not shown) for user control of the multi-functional multimedia playing device of the invention 100 to perform either a digital photo display function, a video playback function, an audio playback function, or a video/audio recording function.

The digital photo displaying module 210 is used to display the digital photo files that are stored in the data storage module 140 through the screen display module 110 under control of the user with the control module 150, for the purpose of allowing the user to browse through the digital photos that are prestored in the multi-functional multimedia playing device of the invention 100.

The video playback module 220 is used to play back the digital video files that are stored in the data storage module 140 through the screen display module 110 under control of the user with the control module 150, for the purpose of allowing the user to view the video programs that are prestored in the multi-functional multimedia playing device of the invention 100.

The audio playback module 230 is, for example, an MP3-compliant audio playback module, which is used to play back the digital audio files that are stored in the data storage module 140 through the audio output module 120 under control of the user with the control module 150, for the purpose of allowing the user to listen to the audio programs that are prestored in the multi-functional multimedia playing device of the invention 100.

The video/audio recording module 240 is connectable by way of the multimedia data input/output interface cluster 130 to an external video/audio producing unit 10 (such as a VCD/DVD player, a TV unit, a camcorder, and so on), for recording a video/audio data stream produced by the video/audio producing unit 10 under control of the user with the control module 150, and then storing the recorded video/audio data stream into the data storage module 140.

In practical application, the user can utilize the control module 150 to activate one of the four functions provided by the multi-functional multimedia playing device of the invention 100 (i.e., digital photo display function, video playback function, audio playback function, or video/audio recording function), and then use the control module 150 to control the selected function for the user to either browse digital photos, view video programs, listen to music and speeches, or record video/audio programs.

If the user selects the digital photo display function, the control module 150 will command the digital photo displaying module 210 to display user-selected digital photos on the screen display module 110 that are prestored in the data storage module 140 or the externally-connected compact flash card 50, allowing the user to utilize the multi-functional multimedia playing device of the invention 100 to browse through the digital photos.

If the user selects the video playback function, the control module 150 will command the video playback module 220 to play back user-selected video files on the screen display module 110 that are prestored in the data storage module 140 and meanwhile output the audio part of the video file through the audio output module 120, allowing the user to utilize the multi-functional multimedia playing device of the invention 100 to watch video programs.

If the user selects the audio playback function, the control module 150 will command the audio playback module 230 to use the audio output module 120 to play back user-selected audio files that are prestored in the data storage module 140 or external compact flash devices connected to the compact flash interface module 160, allowing the user to utilize the multi-functional multimedia playing device of the invention 100 to listen to audio programs.

If the user selects the video/audio recording function, the user first needs to connect the multi-functional multimedia playing device of the invention 100 by means of the video/audio input interface 131 to an external video/audio producing unit 10, such as a VCD/DVD player, a TV unit, a camcorder, and so on; and then the user needs to utilize the control module 150 to command the video/audio recording module 240 to record the data stream from the video/audio producing unit 10 and store the recorded data into the data storage module 140, allowing the user to later utilize the video playback module 220 or the audio playback module 230 to play back the recorded programs.

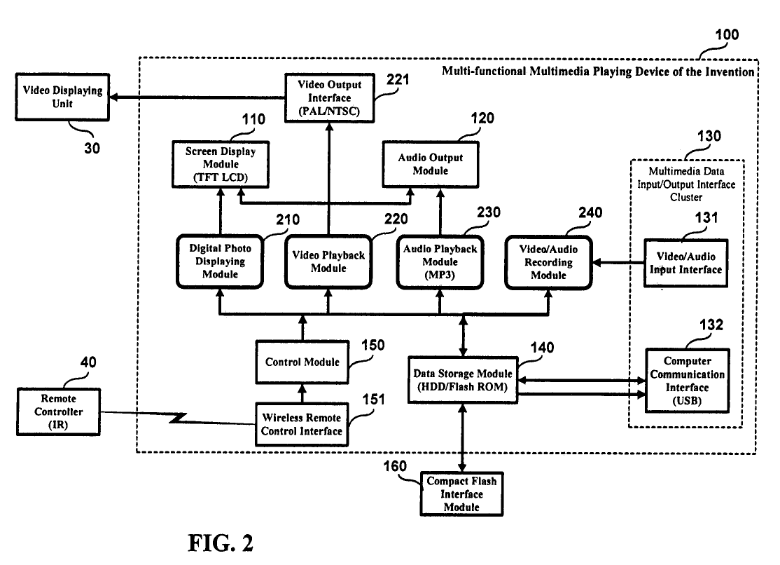

In addition, as shown in FIG. 2, the multi-functional multimedia playing device of the invention 100 can be further optionally equipped with a video output interface 221, such as a standard PAL/NTSC (Phase Alternating Line, National TV Standards Committee) video output interface, for connecting the multi-functional multimedia playing device of the invention 100 to an external video displaying unit 30, such as a large-screen TV unit, for the purpose of forwarding the output video signal from the video playback module 220 to the large-screen video displaying unit 30, instead of the small-screen TFT LCD screen display module 110, so as to provide a better visual effect.

Moreover, as shown in FIG. 2, the multi-functional multimedia playing device of the invention 100 can be further optionally equipped with a wireless remote control interface 151, such as an IR (Infrared) wireless remote control interface, which is internally coupled to the control module 150 for the multi-functional multimedia playing device of the invention 100 to be remotely controllable by the user via a remote controller 40.

In conclusion, the invention provides a multi-functional multimedia playing device which allows the user to utilize a single unit to provide a variety of multimedia playback functions, including a digital photo display function, a video playback function, an audio playback function, and a video/audio recording function, for the user to browse digital photos, view video programs, listen to music and speeches, and record video/audio programs, all on a single unit of device. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A multi-functional multimedia playing device capable of providing a variety of multimedia functions, including a digital photo display function, a video playback function, an audio playback function, and a video/audio recording function;
the multi-functional multimedia playing device comprising:
a screen display module for displaying digital photos and digital videos;
an audio output module for outputting audios;
a multimedia data input/output interface cluster for connection with external video/audio producing unit;
a data storage module, which is used to store various kinds of multimedia data files, including digital photo files, digital video files, and digital audio files;
a digital photo displaying module, which is used to display the digital photo files that are stored in the data storage module on the screen display module;
a video playback module, which is used to play back the digital video files stored in the data storage module on the screen display module;
an audio playback module, which is used to play back the digital audio files stored in the data storage module through the audio output module;
a video/audio recording module, which is connectable by way of the multimedia data input/output interface cluster to an external multimedia data producing unit for recording a video/audio data stream produced by the external multimedia data producing unit and storing recorded video/audio data stream into the data storage module;
a control module, which is used for user-initiated control on the digital photo displaying module, the video playback module, the audio playback module, and the video/audio recording module, for desired digital photo display function, video playback function, audio playback function, or video/audio recording function; and
a compact flash interface module for the outputting and inputting of multimedia data.

2. The multi-functional multimedia playing device of claim 1, wherein the screen display module is a color TFT LCD module.

3. The multi-functional multimedia playing device of claim 1, wherein the multimedia data input/output interface cluster includes:
a video/audio input interface, which is used for connection to an external video/audio producing unit for transferring a video/audio data stream from the video/audio producing unit to the video/audio recording module; and
a computer communication interface, which is used for connection to an external computer system for downloading multimedia data files from the computer system to the data storage module.

4. The multi-functional multimedia playing device of claim 3, wherein the computer communication interface is a USB-compliant communication interface.

5. The multi-functional multimedia playing device of claim 1, wherein the data storage module includes a hard disk drive or a flash memory module, wherein the hard disk drive is used to store various kinds of multimedia data files while the flash memory module is used to store control programs.

6. The multi-functional multimedia playing device of claim 1, wherein the audio playback module is an MP3-compliant audio playback module.

7. The multi-functional multimedia playing device of claim 1, further comprising:
a video output interface for connecting the video playback module to an external video displaying unit, for the purpose of forwarding the output video signal from the video playback module to be displayed on the externally-connected video displaying unit.

8. The multi-functional multimedia playing device of claim 7, wherein the video output interface is a PAL/NTSC-compliant video output interface.

9. The multi-functional multimedia playing device of claim 1, further comprising:
a wireless remote control interface, which is internally coupled to the control module for the multi-functional multimedia playing device of the invention to be remotely controllable via a remote controller.

10. The multi-functional multimedia playing device of claim 9, wherein the wireless remote control interface is an infrared-based wireless remote control interface.
